(19) United States
(12) Patent Application Publication
(10) Pub. No.: US 2025/0223001 A1
(43) Pub. Date: Jul. 10, 2025

(54) FRONT FAIRING STORAGE COMPARTMENT FOR MOTORCYCLE

(71) Applicant: Ran Hezkiahu, Scottsdale, AZ (US)

(72) Inventor: Ran Hezkiahu, Scottsdale, AZ (US)

(21) Appl. No.: 19/006,452

(22) Filed: Dec. 31, 2024

Related U.S. Application Data
(60) Provisional application No. 63/618,401, filed on Jan. 8, 2024.

(51) Int. Cl. B62J 9/21; B62J 9/27; B62J 9/30; B62J 17/02

(52) U.S. Cl. CPC B62J 9/21; B62J 9/27; B62J 9/30; B62J 17/02

(57) ABSTRACT

A motorcycle accessory includes a front fairing compartment including a front folding panel pivotally coupled to a hinge assembly. The hinge assembly includes one or more hinge mounting provisions for affixing the hinge assembly to a fork or other portion of a motorcycle.

### FIELD OF THE INVENTION

The present invention generally relates to fairing for motorcycles, and particularly to a front fairing storage compartment for a motorcycle.

### BACKGROUND OF THE INVENTION

A motorcycle fairing is a shell placed over the frame of a motorcycle, with the primary purpose to reduce air drag and improve fuel economy. The secondary functions are to protect the rider from airborne hazards and to protect the engine components in the case of an accident. A motorcycle windshield may be an integral part of the front fairing.

The front fairing employed in most motorcycles is generally made of a synthetic resin and molded to varying shapes. Some front fairings are one central piece, while others include left and right fairing segments, and still others include left, center and right fairing segments. Most fairings fit around a top portion of the front fork assembly. Some fairings extend down to under the motorcycle engine. Some fairings enclose the instrument panel and the headlight unit.

### SUMMARY

The present invention seeks to provide a front fairing storage compartment (or simply front fairing compartment) for a motorcycle, as is described more in detail hereinbelow. For example, the invention may be used to store tools, food, binoculars, maps, and many other items. The compartment folds down to place in or take out items to or from the compartment. The compartment folds up to be locked to the frame or other portion of the motorcycle.

The front fairing compartment can be mounted on most motorcycles, no matter whether the motorcycle has or does not have a headlight.

The front folding panel of the front fairing compartment can be opened in one or multiple directions; the main direction is preferably downwards so that tools or other items are visible and easily accessible to the rider. The front folding panel of the front fairing compartment may be locked to the motorcycle frame or other portion of the motorcycle in the closed position, such as by a push-button lock.

Tools and equipment may be mounted on the folding panel or on the mounting panel that is connected to the front fork or other portion of the motorcycle.

The front folding panel or the mounting panel may include pockets and mounting points for securely storing items on the plate.

There is thus provided in accordance with a non-limiting embodiment of the invention a motorcycle accessory including a front fairing compartment including a front folding panel pivotally coupled to a hinge assembly, the hinge assembly including one or more hinge mounting provisions for affixing the hinge assembly to a fork or other portion of a motorcycle.

In accordance with a non-limiting embodiment of the invention the front folding panel includes a closure element, (such as a latch, screw, rubber band, bungee cord and the like) for securing the front folding panel in a closed position.

In accordance with a non-limiting embodiment of the invention the closure element includes a push-button lock that locks onto a head of a post affixed to the motorcycle.

In accordance with a non-limiting embodiment of the invention the front folding panel includes one or more item mounting provisions for storing thereon items.

In accordance with a non-limiting embodiment of the invention the front folding panel is formed with a lower notch.

In accordance with a non-limiting embodiment of the invention the motorcycle accessory further includes a mounting panel, which includes one or more item mounting provisions for storing thereon items.

In accordance with a non-limiting embodiment of the invention the hinge assembly includes a first hinge bracket coupled to the front folding panel and a second hinge bracket configured to be coupled to the mounting panel or to the frame or other portion of the motorcycle, and a hinge pin pivotally coupled to the first hinge bracket and the second hinge bracket.

In accordance with a non-limiting embodiment of the invention the hinge pin is slidingly received in a channel formed in the first hinge bracket.

In accordance with a non-limiting embodiment of the invention the first hinge bracket is coupled to the second hinge bracket with an adaptor member that has multiple holes for receiving a pivot pin pivotally coupled to the second hinge bracket.

### BRIEF DESCRIPTION OF DRAWINGS

The present invention will be understood and appreciated more fully from the following detailed description, taken in conjunction with the drawings in which:

FIG. 1 is a simplified perspective illustration of a front fairing storage compartment, in accordance with a non-limiting embodiment of the present invention.

FIG. 2 is a simplified side view illustration of the front fairing compartment.

FIG. 3 is simplified rear perspective illustration of the front fairing compartment, showing mounting features to the front suspension or fork or other portion of the motorcycle, and in a closed (folded up), locked position.

FIG. 4 is simplified front perspective illustration of the front fairing compartment mounted to the motorcycle and in a closed, locked position.

FIGS. 5 and 6 are simplified side-view and perspective illustrations, respectively, of the front fairing compartment in a folded down, open position.

FIGS. 7A and 7B are simplified perspective illustrations of an adaptor member that has multiple holes for receiving a pivot pin.

FIGS. 8A and 8B are simplified perspective illustrations of a front fairing storage compartment with an arcuate hinge member, in accordance with another non-limiting embodiment of the present invention, in which the front folding panel is in open and closed positions, respectively.

FIGS. 9A, 9B and 9C are simplified perspective illustrations of another hinge assembly and clasp, in accordance with another non-limiting embodiment of the present invention.

FIGS. 10A and 10B are more enlarged illustrations of the assembly of FIGS. 9A-9C.

FIGS. 11A, 11B, and 11C are simplified perspective illustrations of the assembly of FIGS. 9A-9C, showing three different positions that give different available storage space by adjusting how far out the front folding panel can be moved, with FIG. 11A having the most available storage space and FIG. 11C having the least available storage space.

### DETAILED DESCRIPTION

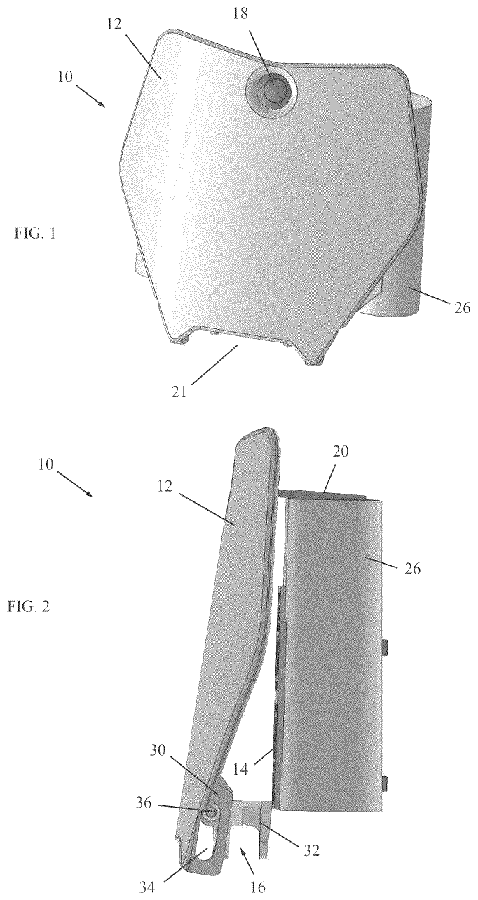

Reference is now made to FIGS. 1-6, which illustrate a front fairing storage compartment 10, in accordance with a non-limiting embodiment of the present invention.

The front fairing compartment 10 may include a front folding panel 12 pivotally coupled to a hinge assembly 16. The front fairing compartment 10 may also include a mounting panel 14. The hinge assembly 16 may be coupled to a fork or other portion of the motorcycle, or alternatively, may be coupled to mounting panel 14.

The front folding panel 12 may include a closure element 18, which can be used to hold and secure the front folding panel 12 in a closed position (the closed position is the folded up position and is shown in FIGS. 1, 2, 3, and 4). The closure element 18 may be, without limitation, a latch, screw, rubber band, bungee cord and the like. In one non-limiting embodiment, closure element 18 is a push-button lock that locks onto the head of a post 20, affixed to the frame or other portion of the motorcycle (not shown). In such an embodiment, the head of post 20 may be lockingly received in a spring-loaded catch of the push-button lock, and the push button can be pressed to release (unlock) the head of post 20 from closure element 18 in order to open (fold down) front folding panel 12. The invention is not limited to a push-button lock and other mechanisms, such as but not limited to, a clasp, snap, thumbscrew, key-operated lock and others, may be used to hold and secure the front folding panel 12 in the closed position.

The post 20 may be adjustable around its axis so that it can be adjusted outwards or inwards of the motorcycle to provide adjustable storage space.

The front folding panel 12 may be flat or curved. The front folding panel 12 may include one or more item mounting provisions 22 (FIG. 6), such as but not limited to, shelves or pockets or mounting posts, so that a wide variety of items can be safely stored on front folding panel 12. As seen in FIG. 1, front folding panel 12 may be formed with a lower notch 21 to accommodate the front mudguard of the motorcycle.

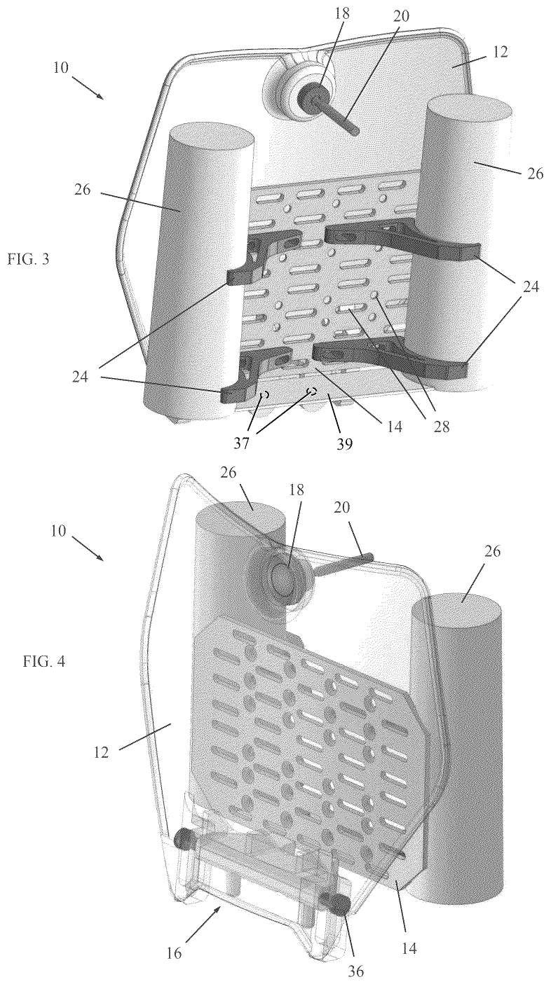

The mounting panel 14 may be flat or curved. The mounting panel 14 may include one or more mounting provisions 24 (FIG. 3), such as brackets, for affixing the mounting panel 14 to the front suspension or fork 26 or other portion of the motorcycle. The mounting panel 14 may also include one or more item mounting provisions 28 (FIGS. 3 and 6), such as but not limited to, slots or holes (the holes could be threaded), or shelves or pockets, so that a wide variety of items can be safely stored on mounting panel 14.

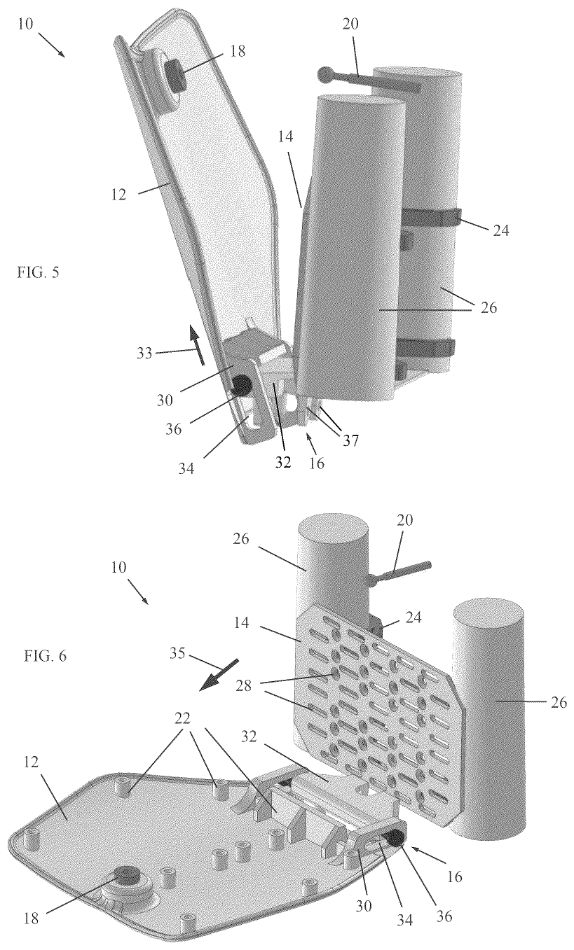

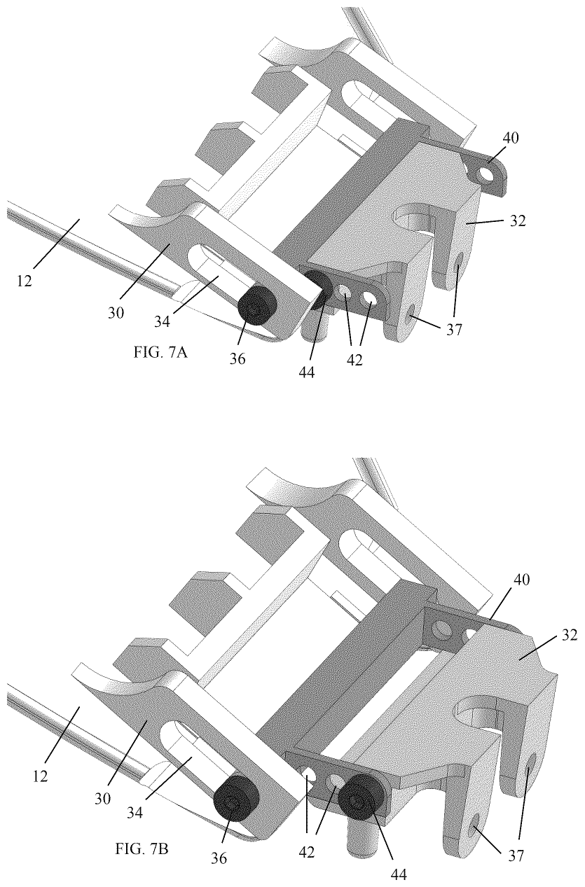

Reference is now made in particular to FIGS. 5 and 6. The hinge assembly 16 may include, without limitation, a first hinge bracket 30 coupled to front folding panel 12 (first hinge bracket 30 may be molded as one unitary piece with front folding panel 12, or may be a separate pieced joined to front folding panel 12). The hinge assembly 16 may include, without limitation, a second hinge bracket 32, which may include one or more hinge mounting provisions 37 (such as mounting holes-seen in FIGS. 5 and 7A-7B, and shown in hidden lines in FIG. 3) so that second hinge bracket 32 can be coupled to some portion 39 (FIG. 3) of the motorcycle or to mounting panel 14. The first hinge bracket 30 may be formed with a channel 34, A hinge pin 36, pivotally coupled to a portion of second hinge bracket 32, may be received in channel 34. In this manner, when opening front folding panel 12, the front folding panel 12 is first lifted upwards (in the direction of arrow 33 in FIG. 5) so that channel 34 slides upwards with respect to hinge pin 36, and then front folding panel 12 is folded outwards (that is, pivots about hinge pin 36) in the direction of arrow 35 in FIG. 6. This arrangement provides a full opening outwards of front folding panel 12.

Reference is now made to FIGS. 7A and 7B. The first hinge bracket 30 may be coupled to the second hinge bracket 32 with an adaptor member 40 that has multiple holes 42 for receiving a fastener 44 coupled to second hinge bracket 32. This embodiment increases the available storage space by adjusting how far out the front folding panel 12 can be moved.

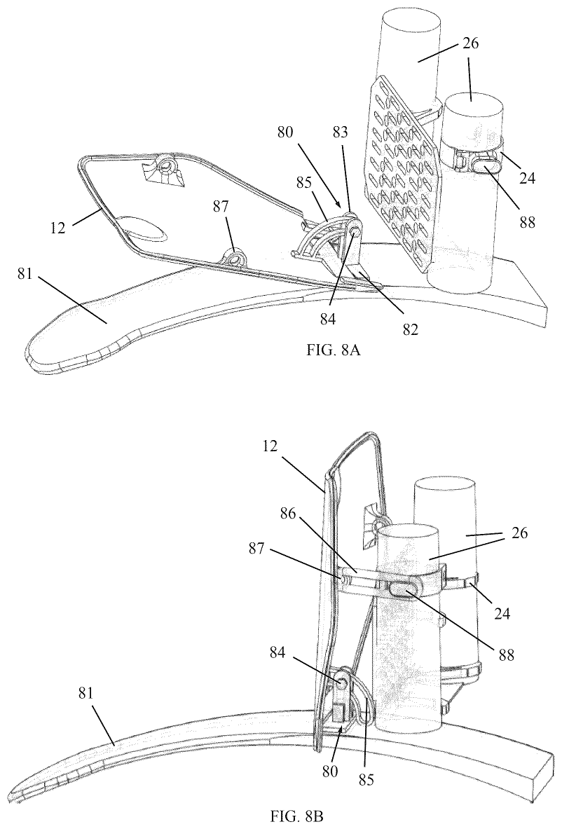

In the above embodiment, it has been mentioned that portions of the hinge assembly (such as the post or the multiple-hole adaptor member) may be adjustable outwards or inwards to provide adjustable storage space. Other embodiments with this feature are now described with reference to FIGS. 8A-11C.

Reference is now made to FIGS. 8A and 8B. In this embodiment, front folding panel 12 is pivotally coupled to a hinge assembly 80 which may be mounted on a front mudguard 81. The hinge assembly 80 may include a base 82 (the part mounted on front mudguard 81), hinge pin posts 83 that extend up from base 82 and which support a hinge pin 84, and an arcuate hinge member 85 coupled to front folding panel 12, which has an inner arcuate guide which slides over the hinge pin 84. A clasp 86, such as but not limited to, an elastic band (FIG. 8B), may be coupled to a lug 87 on front folding panel 12 and to a clasp receiving member 88 mounted on one of the mounting provisions 24 that is secured to the front suspension or fork 26. The clasp 86 is used to secure front folding panel 12 in the upright closed position when clasp 86 is secured to both lug 87 and clasp receiving member 88, as in FIG. 8B.

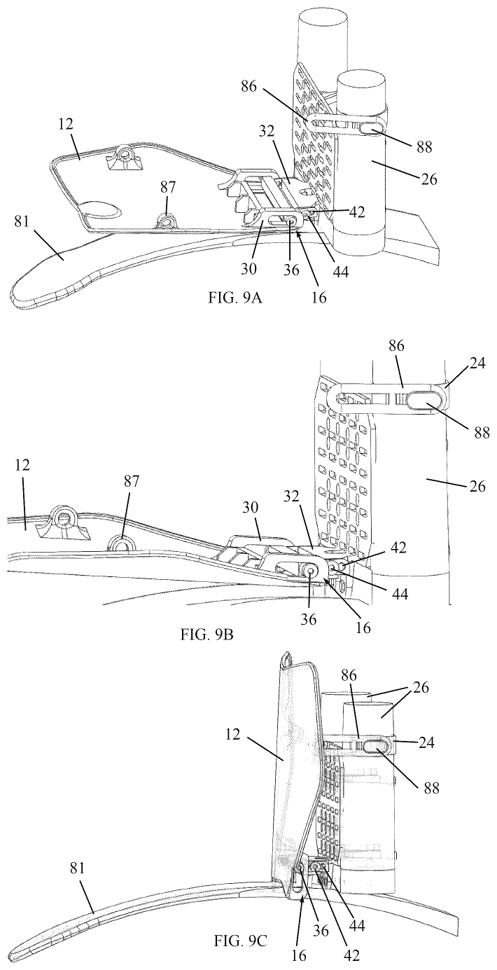

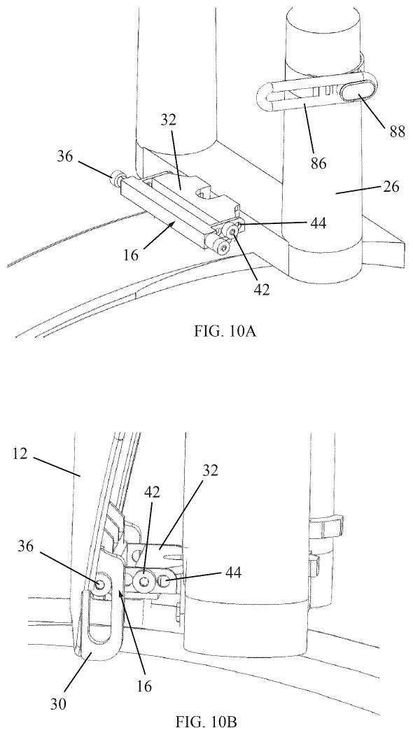

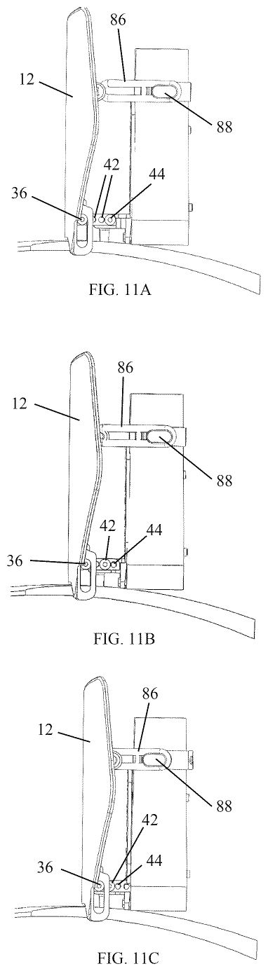

Reference is now made to FIGS. 9A, 9B and 9C, and FIGS. 10A and 10B. The clasp 86, lug 87 and clasp receiving member 88 may be used with the hinge assembly 16 that has hinge pin 36, and first hinge bracket 30 coupled to second hinge bracket 32 with adaptor member 40 that has multiple holes 42 for receiving fastener 44 coupled to second hinge bracket 32. As seen in FIGS. 11A, 11B, and 11C, this embodiment increases the available storage space by adjusting how far out the front folding panel 12 can be moved.

1. A motorcycle accessory comprising:
a front fairing compartment comprising a front folding panel pivotally coupled to a hinge assembly, said hinge assembly comprising one or more hinge mounting provisions for affixing said hinge assembly to a fork or other portion of a motorcycle.

2. The motorcycle accessory according to claim 1, wherein said front folding panel comprises a closure element for securing said front folding panel in a closed position.

3. The motorcycle accessory according to claim 2, wherein said closure element comprises a push-button lock that locks onto a head of a post affixed to the motorcycle.

4. The motorcycle accessory according to claim 1, wherein said post is adjustable outwards or inwards to provide adjustable storage space.

5. The motorcycle accessory according to claim 1, wherein said front folding panel comprises one or more item mounting provisions for storing thereon items.

6. The motorcycle accessory according to claim 1, wherein said front folding panel is formed with a lower notch.

7. The motorcycle accessory according to claim 1, wherein said mounting panel comprises one or more item mounting provisions for storing thereon items.

8. The motorcycle accessory according to claim 1, wherein said hinge assembly comprises a first hinge bracket coupled to said front folding panel and a second hinge bracket, and a hinge pin pivotally coupled to said first hinge bracket and said second hinge bracket.

9. The motorcycle accessory according to claim 8, wherein said hinge pin is slidingly received in a channel formed in said first hinge bracket.

10. The motorcycle accessory according to claim 8, wherein said first hinge bracket is coupled to said second hinge bracket with an adaptor member that has multiple holes for receiving a fastener coupled to said second hinge bracket.
